(19) United States
(12) Patent Application Publication
(10) Pub. No.: US 2024/0021847 A1
(43) Pub. Date: Jan. 18, 2024

(54) FUEL CELL HUMIDIFIER

(71) Applicant: CORE Energy Recovery Solutions Inc., Vancovuer (CA)

(72) Inventors: Kathleen Marie MEGALE, Vancouver (CA); Ryan HUIZING, Vancouver (CA); Jonathan LO, Vancouver (CA); Christopher BARR, Vancouver (CA); Reza AMINZADEH, Vancouver (CA)

(21) Appl. No.: 18/030,642

(22) PCT Filed: Oct. 8, 2021
(86) PCT No.: PCT/CA2021/051425

§ 371 Date: Apr. 6, 2023

Related U.S. Application Data
(60) Provisional application No. 63/090,028, filed on Oct. 9, 2020.

(51) Int. Cl. H01M 8/04119; H01M 8/248

(52) U.S. Cl. CPC H01M 8/04149; H01M 8/248; H01M 2008/1095

(57) ABSTRACT

Example embodiments provide fuel cell humidifiers. An example humidifier comprises a stack of unit cells. Each of the unit cells may comprise a separator having a perimeter frame and first and second major faces, a first membrane sheet bonded to the perimeter frame on the first major face of the separator and a second membrane sheet bonded to the perimeter frame on the second major face of the separator. The perimeter frame and the first and second membrane sheets may define a cavity in an interior of the perimeter frame. Opposed frame ends of the perimeter frame may be apertured to allow a first flow to flow through the cavity in a first direction. The separator may include first and second ridges that extend across first and second frame ends. In the stack of unit cells the first and second ridges may space the unit cells apart from one another by contact with the separators of adjacent unit cells to provide passages extending through the stack of unit cells in a second direction transverse to the first direction. In some embodiments, the unit cells can all be stacked in the same orientation.

### CROSS-REFERENCE TO RELATED APPLICATIONS

This application claims priority from U.S. application No. 63/090,028 filed 9 Oct. 2020 and entitled FUEL CELL HUMIDIFIER which is hereby incorporated herein by reference for all purposes. For purposes of the United States of America, this application claims the benefit under 35 U.S.C. § 119 of U.S. application No. 63/090,028 filed 9 Oct. 2020 and entitled FUEL CELL HUMIDIFIER.

### FIELD

The present inventions relate to membrane-based gas exchange systems. Particular embodiments provide humidifiers. The inventions may be embodied, for example, in humidifiers for fuel cells.

### BACKGROUND

It is possible to exchange gases through a membrane which separates two flows. For example, a humidifier may include a membrane that separates a flow of air or another gas that is more humid from a second flow of air or another gas that is less humid. Water vapor may be transported through the membrane from the more humid flow to the less humid flow, thereby humidifying the less humid flow.

In many applications it is desirable to make a gas exchange system relatively compact while still providing enough membrane surface area to achieve the desired gas transfer. This can be achieved by a flat-sheet membrane humidifier having multiple gas distribution layers separated by membranes. Each layer may carry one of the flows. The flows may be oriented parallel to one another (e.g. in a “counter-flow” arrangement) or to cross one another (e.g. in a “cross-flow” arrangement).

Membrane humidifiers include flat-sheet membrane or hollow-fiber membrane type humidifiers. In hollow-fiber humidifiers, a membrane is provided in the form of hollow fibers. The hollow fibers are tubular and have interior flow paths which extend along them. The walls of the hollow fibers serve as the functional membrane. Multiple hollow fibers are typically assembled into a fiber bundle and sealed into a housing, Ports and baffles are provided to direct airflow into the fiber bundle. In a hollow-fiber humidifier, one air stream flows through the interiors of the fibers and the other air stream is directed over the outer surfaces of the fibers.

In flat-sheet humidifiers, the membrane is often produced in a continuous roll-to-roll process. Flat membrane layers are then assembled with flow-field plates to make a membrane core. The core is then installed into a housing to direct airflow through the core. Airflow through the core may be cross-flow or counter-flow or in various other geometries, depending on the design of the humidifier core.

Air flow distribution is important in membrane humidifiers. Efficiency of the humidifier is decreased if air flow is not evenly distributed over all membrane surfaces. For hollow-fiber bundles it is difficult to get even air flow distribution around the outsides of the fibers in the bundle. In flat-sheet designs, the flow field typically provides consistent spacing between membranes, and well-defined and more even flow distribution over all the membrane surfaces. For this reason, flat-sheet humidifiers tend to have better vapor transport performance per membrane area, allowing more efficient use of the membrane area in the humidifier. Hollow-fiber membranes also tend to be more expensive than flat-sheet membranes on a per unit area basis. Overall, flat-sheet humidifiers may use less membrane, and lower cost membranes, to achieve similar performance to hollow-fiber humidifiers. Also, flat-sheet designs can often achieve the same performance as a comparable hollow-fiber humidifier within a smaller geometric volume, even though hollow-fiber membranes typically have higher membrane packing densities.

Since the flow distribution in flat-sheet designs can be well-defined, and liquid water can easily be drained from flow passages in typical flat-sheet humidifiers, flat-sheet humidifiers can also have lower pressure losses due to air flow in the channels, compared to hollow-fiber designs, which leads to lower energy consumption by compressors, blowers, or other devices used to move air through the humidifiers.

One downside of flat-sheet designs compared to hollow-fiber designs is that flow-field plates are an extra component of the humidifier and add cost. Another challenge with flat-sheet designs relative to hollow-fiber designs, is that in flat-sheet designs there are generally many more sealing surfaces that must meet tight manufacturing tolerances, and must be robust throughout the life of the humidifier.

It can be a significant challenge to manufacture flat-sheet humidifiers in a way that is cost effective and provides reliable sealing so that the flows do not mix except by transfer of species (e.g. water vapor) through the membrane.

One important application of humidifiers is in the field of fuel cells. Fuel cells may be used to provide electrical power for a wide variety of applications. One field in which fuel cells have particular promise is the field of electric vehicles.

Fuel cells typically include a membrane electrode assembly, in which the membrane electrolyte is selectively permeable to ions. A fuel is supplied on a first side of the membrane electrode assembly and an oxidant is supplied on a second side of the membrane electrode assembly. The fuel undergoes an electrochemical half reaction at a first electrode and the oxidant undergoes an electrochemical half reaction at a second electrode. At least one of these half reactions releases ions which pass through the membrane electrolyte and participate in the other half reaction. The combined electrochemical reactions create a potential difference between the first and second electrodes and can supply an electrical current to a load.

For example, a fuel cell may use hydrogen gas (H₂) as a fuel and oxygen (which may be oxygen in air) as the oxidant. The hydrogen may undergo the reaction:

H₂→2H⁺+2e⁻

The electrons may be used to supply an electrical current to a load. The membrane electrolyte is not conductive to the electrons. The protons (H+ ions) pass through the membrane electrolyte where they participate with oxygen molecules in the reaction:

O₂+4e⁻+4H⁺→2H₂O.

Different fuel cells may use other suitable fuels and/or oxidants.

Many of the best membranes used in fuel cells require hydration. Such membranes may, for example, comprise ionomeric polymers that absorb water, and/or that transport water molecules along with the ions (generally protons) involved in the electrochemical reaction. The performance of such membranes in fuel cells can deteriorate significantly if the membrane is allowed to dry out. Membranes are more likely to dry out (become dehydrated) as their operating temperature increases. However, the overall efficiency of a fuel cell can be improved by operating the fuel cell at higher temperatures, at which temperatures the fuel cell membrane electrolyte is more likely to become dehydrated. An example of a membrane that may be used as an electrolyte in a fuel cell is a Nafion™ membrane. Polymer electrolyte membrane fuel cells (PEMFC) are an example of a type of fuel cell that uses such membranes.

To avoid fuel cells becoming dehydrated, water may be delivered together with the fuel and/or oxidant that is supplied to the fuel cell. For example, a stream of oxygen (or air) may be passed through a humidifier which introduces water into the stream. The water is carried to the fuel cell membrane electrolyte along with the oxygen or air.

Since water is produced in fuel cells as part of the fuel cell reaction, the cathode exhaust gas of a PEMFC is often at a relatively high temperature and has high moisture content and high relative humidity. This exhaust stream is typically depleted of oxygen that has been consumed as a reactant in the fuel cell reaction. A fuel cell humidifier can be used to capture the moisture from the fuel cell cathode exhaust stream and return the moisture to the fuel cell cathode supply stream.

In a membrane-based fuel cell humidifier the moisture-laden and oxygen-depleted fuel cell cathode exhaust stream is directed over one surface of a membrane, and the dry, oxygen-rich fuel cell cathode air supply is directed over the opposing surface of the membrane. The membrane is selective to allow water vapor to transport through the membrane, but does not allow mixing of nitrogen and oxygen gases between the supply and exhaust gas streams. The membrane humidifier thus acts as a passive device, allowing moisture from the fuel cell exhaust stream to be returned to fuel cell cathode supply stream.

There is a need for fuel cell humidifiers that are durable and cost effective.

### SUMMARY

The present invention has a number of aspects. These include, without limitation:
A. humidifiers and humidifier cores, for example apparatus for humidifying fuel cell reactant streams;
B. Replaceable cores (or cartridges) for humidifiers;
C. separators for fuel cell humidifiers or other membrane-based gas exchangers; and
D. methods for making fuel cell humidifiers or other membrane-based gas exchangers.

One aspect of the invention provides a humidifier comprising a stack of unit cells. Each of the unit cells comprises a separator having a perimeter frame and first and second major faces. A first membrane sheet is bonded to the separator on the first major face of the separator and a second membrane sheet bonded to the separator on the second major face of the separator. The perimeter frame and the first and second membrane sheets define a cavity in an interior of the perimeter frame. Opposed first and second frame ends of the perimeter frame are apertured to allow a first flow to flow through the cavity in a first direction and the separator includes first and second ridges that extend respectively across the first and second frame ends. In the stack of unit cells the first and second ridges space the unit cells apart from one another by contact with the separators of adjacent unit cells to provide transverse passages extending through the stack of unit cells in a second direction transverse to the first direction. In some embodiments a height of the stack of unit cells is entirely determined by the heights of the first and second ridges and thicknesses of the separators.

In some embodiments the first and second ridges are respectively inset inwardly from outer edges of the first and second frame ends. In such embodiments portions of the first frame ends between the first ridges and the outer edges of the first frame end may be spaced apart from one another in the stack of unit cells by first gaps and the first gaps may contain a material (e.g. an adhesive and/or sealant) that bonds the adjacent unit cells together. The material may, for example, comprise a UV curable adhesive. In some embodiments the frames are bonded together or bonded together and sealed by a welding process, such as laser or thermal welding.

In some embodiments portions of second frame ends between the second ridges and the outer edges of the second frame end are spaced apart from one another in the stack of unit cells by second gaps and the second gaps contain a material (e.g. an adhesive and/or sealant) that bonds the adjacent unit cells together.

In some embodiments the first and second ridges are respectively on first and second opposing faces of the separators. The separators are optionally each symmetrical with respect to rotations of 180 degrees about a transverse axis centered in the separators. The separators optionally include a third ridge on the first frame end on the second face of the separator, wherein an outer edge of the ridge is aligned with an inner edge of the first ridge. The third ridge, if present, may, for example have a height measured from a side of the perimeter frame that is less than a height of the second ridge measured from the side of the perimeter frame.

In some embodiments the first and second membrane sheets each comprises a porous substrate and a water vapor permeable coating on one face of the porous substrate. The first and second membrane sheets may each be oriented so that the water vapor permeable coating faces away from the separator to which the first and second membrane sheets are attached. In some embodiments the porous substrates comprise a polyphenylene sulfide (PPS), polyethylene terephthalate (PET), polypropylene (PP) or other suitable plastic.

In some embodiments the separators comprise PPS, PET, PP, or other plastics. In some embodiments the plastic separator is over-molded on another material (e.g. another plastic). For example, the porous substrates of the first and second membrane sheets and the substrate may each comprise PPS plastic.

In some embodiments the porous substrates of the membranes and the spacers each comprise the same plastic material or plastic materials of the same polymer family (e.g. PPS, PET, PP, or other plastics). The bonding of the membrane sheets to the separator may comprise bonding the plastic material of the membrane sheet to the same plastic material of the separator.

In some embodiments the first and second membrane sheets are bonded to the separator around a periphery of the cavity (e.g. bonded to the separator around the perimeter frame of the separator). In some embodiments the bonds seal the membrane sheet to the separator around the cavity.

In different example embodiments, membrane sheets may be made of membrane materials that have any of various constructions. In some embodiments the membrane sheets comprise multi-layer membrane materials. For example, a membrane material may include a support layer (such as a layer of a non-woven fibrous polymer material), a microporous layer, and a water vapour selective air-impermeable coating layer. In some embodiments where a membrane sheet includes a support layer the separator may be bonded to the support layer of the membrane sheet.

Some embodiments comprise membrane sheets of a membrane material that comprises or consists of a microporous layer and a water vapour selective coating layer on the microporous layer. In some embodiments where a membrane sheet includes a microporous layer, the separator may be bonded to the microporous layer of the membrane sheet.

Some embodiments comprise membrane sheets of a membrane material that includes one or more additional layers. For example a surface treatment may be applied to the selective layer of a membrane material.

In some embodiments, membrane sheets include membrane materials in which two microporous layers are attached to opposing faces of the selective layer, such that the selective layer is located between the two microporous layers. A support layer is optionally provided on one or both faces of the membrane material.

In some embodiments, membrane sheets include membrane materials in which a support layer is bound between two microporous layers, and a selective coating is applied to any of the microporous layer surfaces. In some embodiments a surface of a selective layer of a membrane sheet is bonded to the separator.

In some embodiments the humidifier comprises a plurality of flow field elements extending across the cavity between the first and second frame ends. The flow field elements are spaced apart to define channels extending across the cavity. Opposing surfaces of the flow field elements may be coplanar with first and second major faces of the separator. In some embodiments adjacent ones of the flow field elements are spaced apart from one another by distances in the range of 1 to 5 mm. Some or all of the separators optionally comprise a plurality of lateral supports that extend between adjacent ones of the flow field elements and are dimensioned to not occlude the channels. In some embodiments the first and second frame ends are each formed to provide a plurality of apertures that extend through the first and second frame ends and each open into a corresponding one of the channels. The apertures are optionally formed to have drafted walls.

In some embodiments the cavity has an aspect ratio of width:length in the range of 1:1.2 to 1.2:1.

In some embodiments the transverse passages have heights that are greater than a thickness of a portion of the perimeter frame at which the first membrane sheet is bonded to the perimeter frame.

In some embodiments the humidifier comprises a frame surrounding the stack of unit cells, the frame tensioned to apply compression to the stack of unit cells.

Another aspect of the invention provides a unit cell for a humidifier. The unit cell comprises a separator having a perimeter frame and first and second major faces. A first membrane sheet is bonded to the perimeter frame on the first major face of the separator and a second membrane sheet is bonded to the perimeter frame on the second major face of the separator. The perimeter frame and the first and second membrane sheets define a cavity in an interior of the perimeter frame. Opposed first and second frame ends of the perimeter frame are apertured to allow a first flow to flow through the cavity in a first direction. The separator includes first and second ridges that extend respectively across the first and second frame ends.

Another aspect of the invention provides a method for assembling a humidifier or humidifier core, the method comprising: making a plurality of unit cells; stacking a plurality of the unit cells together to form a stack; and bonding the stack of unit cells together. Making the unit cells may comprise attaching a first membrane sheet to a first major face of a separator comprising: a perimeter frame and first and second major faces wherein the perimeter frame is penetrated by apertures that extend from outside edges of the first and second frame ends into a flow field region surrounded by the perimeter frame; and first and second ridges that extend respectively across the first and second frame ends; and attaching a second membrane sheet to a second major face of the perimeter frame opposed to the first major face. The unit cells may be stacked such that in the stack of unit cells the first and second ridges space the unit cells apart from one another by contact with the separators of adjacent unit cells to provide transverse passages extending through the stack of unit cells. In some embodiments, attaching the first membrane sheet to the first major face of a separator comprises aligning the first membrane sheet against an edge of the first ridge. In some embodiments, attaching the second membrane sheet to the second major face of a separator comprises aligning the second membrane sheet against an edge of the second ridge.

In some embodiments the separator comprises third and fourth ridges that extend respectively across the first and second frame ends and are respectively on opposite major faces of the perimeter frame from the first and second ridges and stacking the plurality of unit cells comprises aligning the unit cells in the stack by abutment of the third ridge of one unit cell in the stack with the first ridge of an adjacent unit cell in the stack.

Another aspect of the invention comprises a separator for use in a humidifier. The separator comprises: a perimeter frame and first and second major faces wherein the perimeter frame is penetrated by apertures that extend from outside edges of the first and second frame ends into a flow field region surrounded by the perimeter frame; and first and second ridges that extend respectively across the first and second frame ends.

In some embodiments the separator comprises a plurality of flow field elements extending across the cavity between the first and second frame ends. The flow field elements are spaced apart to define channels extending across the cavity. In some embodiments opposing surfaces of the flow field elements are coplanar with first and second major faces of the separator. In some embodiments adjacent ones of the flow field elements are spaced apart from one another by distances in the range of 1 mm to 5 mm. In some embodiments the separator comprises a plurality of lateral supports that extend between adjacent ones of the flow field elements and are dimensioned to not occlude the channels. In some embodiments the apertures are formed to have drafted walls.

In some embodiments the cavity has an aspect ratio of width:length in the range of 1:1.2 to 1.2:1.

Another example aspect of the invention provides a humidifier or humidifier core that comprises a stack of unit cells. Each of the unit cells may comprise a separator having a perimeter frame and first and second major faces, a first membrane sheet bonded to the perimeter frame on the first major face of the separator and a second membrane sheet bonded to the perimeter frame on the second major face of the separator. The perimeter frame and the first and second membrane sheets may define a cavity in an interior of the perimeter frame. Opposed frame ends of the perimeter frame may be apertured to allow a first flow to flow through the cavity in a first direction. The separator may include first and second ridges that extend across first and second frame ends. In the stack of unit cells the first and second ridges may space the unit cells apart from one another by contact with the separators of adjacent unit cells to provide passages extending through the stack of unit cells in a second direction transverse to the first direction. In some embodiments, the unit cells can all be stacked in the same orientation.

Further aspects and example embodiments are illustrated in the accompanying drawings and/or described in the following description.

It is emphasized that the invention relates to all combinations and subcombinations of the above features, even if these are recited in different claims.

### BRIEF DESCRIPTION OF THE DRAWINGS

The accompanying drawings illustrate non-limiting example embodiments of the invention.

FIG. 1 is a perspective view of a humidifier core according to an example embodiment.

FIG. 1A is an exploded perspective view of a humidifier core unit cell according to an example embodiment.

FIG. 1B is an expanded view of a portion of the humidifier core of FIG. 1.

FIG. 2 is a perspective view of an example separator.

FIG. 2A is an expanded view of a portion of one end of the separator of FIG. 2.

FIG. 2B is an enlarged perspective view showing one half of the separator of FIG. 2.

FIGS. 3A and 3B are partial cross-section views of an example unit cell.

FIG. 3C is a partial cross-section view of an example separator.

FIG. 4 is a side elevation view of an example humidifier core.

FIG. 5 is a partial side elevation view of a humidifier core.

FIG. 6 is a flow chart illustrating an example method for assembling a humidifier core.

FIG. 7 is a side elevation view of two stacked separators having an alternative construction.

FIG. 8 is a partial side elevation view of a humidifier core with ribs arranged along ends of separators.

FIG. 9 is a perspective view of an example separator that has a width that is different from its length.

FIG. 10 is a perspective view of an example counter-flow separator with port openings to form manifolds for gas streams.

FIG. 10A is a perspective view of the separator of FIG. 10 with hidden lines visible.

FIG. 11 is an exploded perspective view of an example humidifier system including a housing which receives a humidifier core.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense. In the drawings, the same reference numerals are used to indicate similar or the same components, parts or features in the different views of an embodiment, and in different illustrated embodiments.

The present technology provides membrane-based gas exchange systems. The following description explains structures and methods for making fuel cell humidifiers according to the present technology. Those of skill in the art will understand that the present technology may be applied in humidifiers for other purposes as well as other membrane-based gas exchange systems.

In a fuel cell humidifier implementing the present technology a water vapor permeable membrane separates a first (drier) flow or stream of fluid being delivered to a fuel cell from a second (more humid) fluid flow or stream that is humid (i.e. contains water vapor). The first flow may, for example, be a supply of oxidant (e.g. air) being supplied to the fuel cell. The second flow may, for example be a flow of exhaust from the fuel cell. Because the second flow is more humid than the first flow, there is net transport of water from the second flow into the first flow through the water vapor permeable membrane in the humidifier.

In typical fuel cell applications the first flow is at a higher pressure than the second flow. For example, the first flow may be pressurized by a blower or compressor, and the second flow may originate downstream from the fuel cell at a lower static pressure.

The water vapor permeable membrane may advantageously be of a type that is ‘selective’ for water vapor (meaning that it is much less permeable to other species, such as oxygen and nitrogen, than it is permeable to water vapor). Some embodiments of the present invention include membranes that are substantially impermeable to air but highly permeable to water vapor. In some embodiments the membranes have a permeance to water vapor that is at least 10,000 gas permeance units (GPU).

In some embodiments the membranes have a selectivity for water vapor relative to air (excluding water vapor) that is at least 100. In some embodiments the membranes have selectivity for water vapor relative to oxygen that is at least 100. In some embodiments the membranes have selectivity for water vapor relative to nitrogen that is at least 100.

The membrane preferably has sufficient mechanical strength to resist deflection when used in the humidifiers described herein at differential pressures between the first and second flow of at least 100 kPa at temperatures up to at least 110° C.

The membrane is preferably resistant to oxidation and hydrolysis at elevated temperatures and pressures. The membrane may be resistant to acidic water, sulfuric acid, and hydrofluoric acid. The membrane is preferably resistant to one or more or all of drying out, humidity cycling, thermal cycling, freeze-thaw cycling, and pressure cycling.

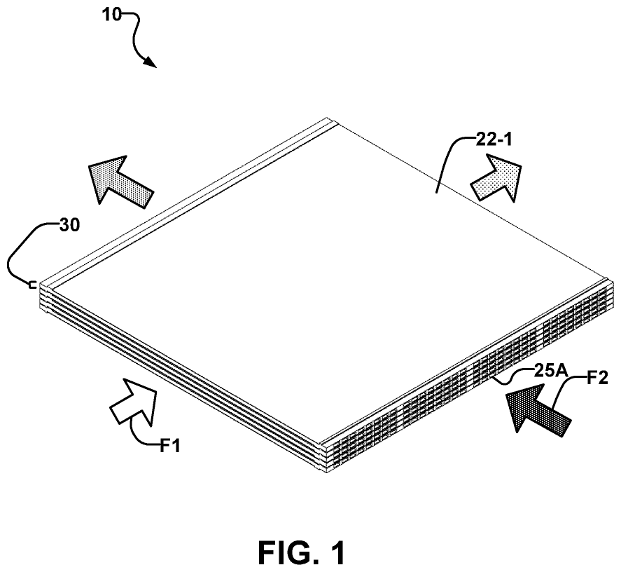

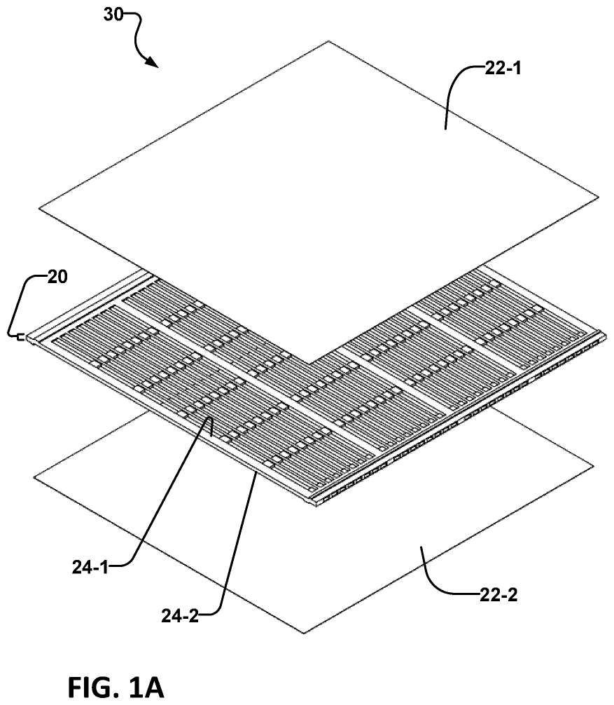

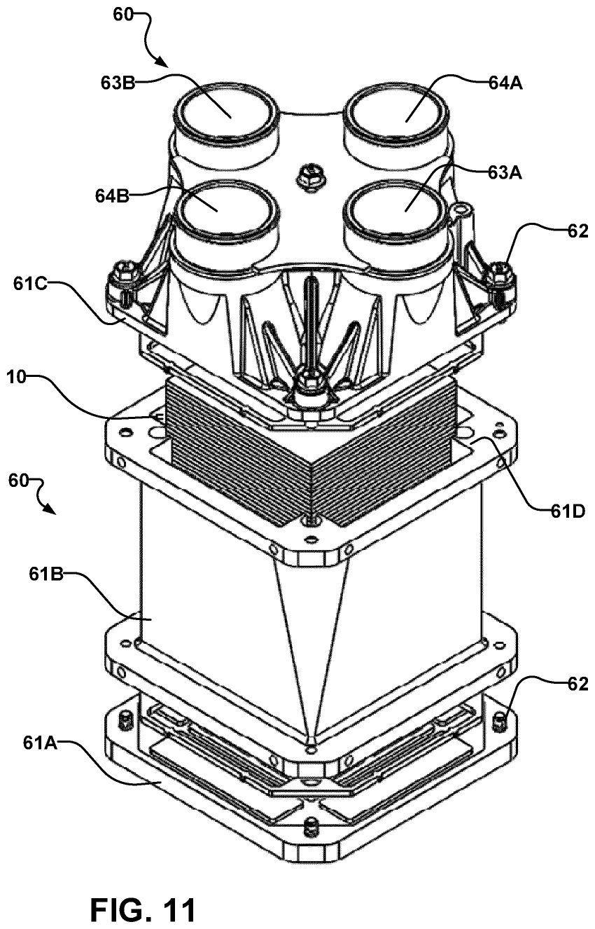

FIG. 1 shows a humidifier core 10 (sometimes also referred to as a humidifier cartridge) according to an example embodiment. A fuel cell humidifier may comprise a housing (see for example housing 60 of FIG. 11) that receives the humidifier core 10, directs the first and second streams into corresponding passages of humidifier core 10, and collects the first and second streams after they have passed through humidifier core 10. Apart from the exchange of moisture that takes place through membranes of humidifier core 10, the humidifier maintains separation of the first and second streams.

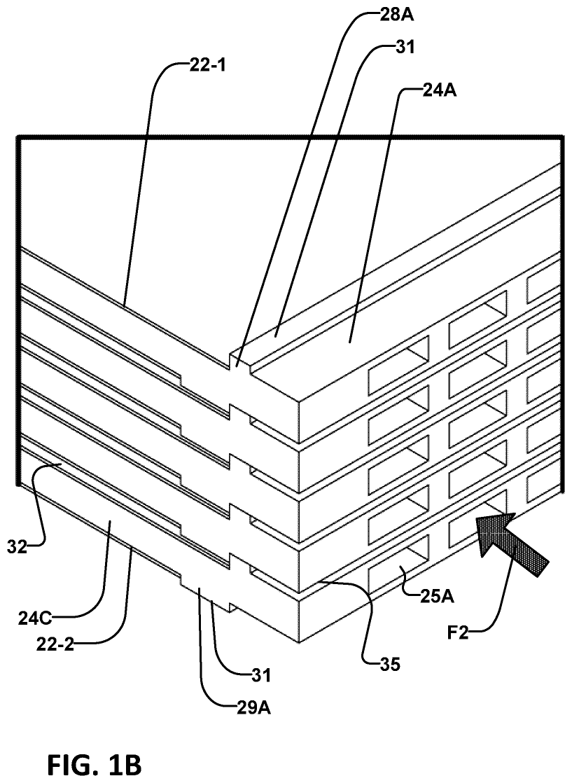

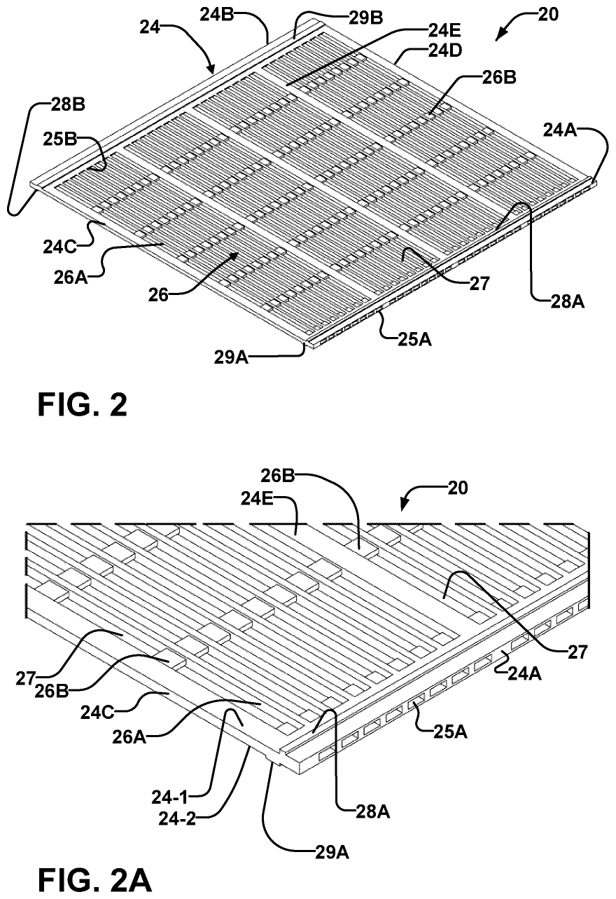

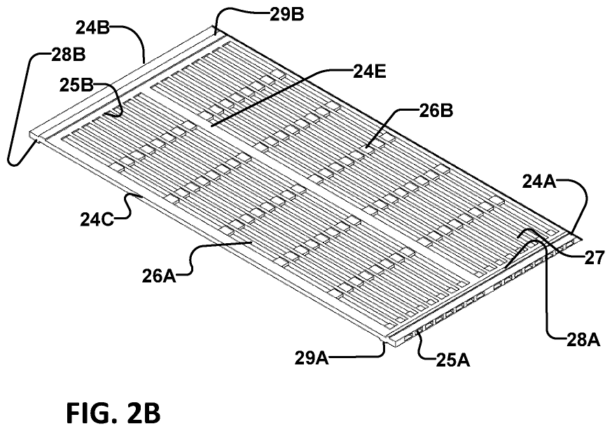

Humidifier core 10 comprises a stack of flow field separators, such as separator 20 shown in FIG. 2. Membrane sheets 22-1 and 22-2 (generally and collectively membrane sheets 22) of water vapor permeable membrane material are respectively located on first face 24-1 (e.g. an upper face) and second face 24-2 (e.g. a lower face—not visible in FIG. 1) of each separator 20 as shown in FIG. 1A. The humidifier core may have end plates 33 (see e.g. FIG. 5) at opposing ends of humidifier core 10. End plates 33 may be shaped to bear against top and bottom separators 20 in the stack. For example, end plates 33 in FIG. 5 have ridges 28C which bear against an adjacent separator 20.

Membrane sheets 22 in humidifier core 10 may be of a type of membrane material that is asymmetric. For example, one face of the membrane material may be designed to be in contact with the first (drier) flow and a second opposing face of the membrane material may be designed to be in contact with the second (more humid) flow. For example, the membrane material may include a substrate that includes a water permeable coating layer on one of its faces. A membrane sheet 22 of Such a membrane material may be oriented such that the coating layer interfaces with the dry, or high-pressure, stream and faces away from the more humid, typically lower pressure stream.

Humidifier core 10 may include membrane sheets 22 made of membrane materials that have any of various constructions. In some embodiments membrane sheets 22 comprise multi-layer membrane materials. For example, a membrane material may include a support layer (such as a layer of a non-woven fibrous polymer material), a microporous layer, and a water vapour selective air-impermeable coating layer. Where a membrane sheet 22 includes a support layer the separator may be bonded to the support layer of the membrane sheet 22.

Another example construction for a membrane material that may be applied for membrane sheets 22 comprises or consists of a microporous layer and a water vapour selective coating layer. Where a membrane sheet 22 includes a microporous layer, the separator may be bonded to the microporous layer of the membrane sheet 22.

Membrane materials that may be applied for membrane sheets 22 may include additional layers. For example a surface treatment may be applied to the selective layer of a membrane material.

In some membrane materials, an additional microporous layer is attached to the selective layer, such that the selective layer is located between two microporous layers, optionally with a support layer on one or both faces of the membrane material. In some membrane materials, a support layer is bound between two microporous layers, and a selective coating is applied to any of the microporous layer surfaces. In some embodiments a surface of a selective layer of a membrane sheet 22 is bonded to the separator.

It is desirable for a humidifier to provide a desired level of moisture exchange between the first and second flows without restricting the flows very much. In particular it is desirable that the humidifier not cause a large pressure drop in the first (drier) flow.

Humidifier core 10 can be considered to be made up of unit cells 30 (see e.g. FIG. 1A). Unit cells 30 each comprise one separator 20 and corresponding membrane sheets 22-1 and 22-2 attached on opposing faces of separator 20 (see e.g. FIG. 1A). Any suitable number of unit cells 30 may be stacked together to form a humidifier core as described below. In some embodiments humidifier core 10 comprises between about 50 to 200 unit cells 30.

Humidifier core 10 has a cross-flow construction. Humidifier core 10 provides passages arranged to carry a first flow F1 through the humidifier core in a first direction and to carry a second flow F2 through the humidifier core in a second direction that crosses the first direction, as indicated by the arrows in FIG. 1. In the embodiment illustrated in FIG. 1 the second direction is substantially orthogonal to the first direction.

The present technology is not limited to cross-flow arrangements. An example of a counter-flow humidifier that embodies the present technology is discussed below in relation to FIGS. 11 and 11A.

Second flow F2 enters humidifier core 10 via inlet apertures 25A (shown in FIG. 1B, and discussed in further detail in reference to FIGS. 2 and 2A). First flow F1 passes through passages 32 between unit cells (see e.g. FIG. 1B).

FIG. 2 illustrates an example separator 20. FIG. 2A is an expanded view of a portion of one end of a separator 20, and FIG. 2B is an enlarged perspective view showing one half of a separator 20. In some embodiments, separator 20 is a unitary structure formed of a material such as a suitable plastic or metal. For example, separator 20 may be formed of polyphenylene sulfide (PPS) plastic. PPS is an example of a material that has desirable properties for separators 20.

Bonding of a membrane sheet 22 to a separator 20 may be facilitated by making the portions of separator 20 and membrane sheet that are bonded to one another of the same materials or of materials that are in the same polymer family. For example, where separator 20 is to be bonded to a microporous layer or a support layer of a membrane sheet 22 the separator 20 and microporous layer or support layer may be made of polymers in the same polymer family (e.g. both PPS plastics or both PET plastics or both PP plastics etc.).

In a structure in which the part of a membrane sheet 22-1 or 22-2 that contacts support 20 is made of the same material as support 20, any of a wide range of bonding processes may be applied to securely bond the membranes to support. In some embodiments, support layers (e.g. non-woven backing layers) of membrane sheets 22 are made of PPS.

PPS is an example of a good choice of material for separators 20 and/or for incorporation in membrane sheets 22. Some properties that PPS may possess are: PPS is dimensionally stable at temperatures and humidity levels to which fuel cell humidifiers may be exposed in operation; PPS is chemically stable and under the expected conditions in a humidifier does not tend to release chemicals that could damage or impair the operation of a down-stream fuel cell; and PPS can be molded which is a good and cost-effective way to mass produce separators 20.

Separator 20 may, for example, be made by injection molding, an additive manufacturing process (e.g. 3D printing) or a subtractive machining process.

In some embodiments, separator 20 comprises a molded part of a first material that is over-molded with one or more second materials. For example, an over-molded material or materials may be provided to facilitate or optimize bonding of membrane sheets 22-1 and 22-2 to separator 20 (e.g. a material that is less expensive than PPS or has properties that are better than PPS in some way may be over-molded with PPS or another material chosen to facilitate ultrasonic welding or another process of bonding a separator 20 to membrane sheets 22-1 and 22-2. As another example, an over-molded material may be used to provide very thin regions (such as to provide lateral supports in a separator). Polypropylene (PP) is an example of a material that may be used to form very thin forms or features.

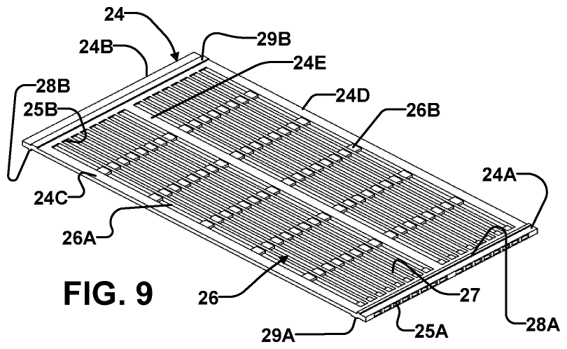

Separator 20 comprises a frame 24 which, in the example shown in FIG. 2, is approximately square in plan view. In some embodiments frame 24 is rectangular (see e.g. FIG. 9) or another geometric shape such as hexagonal or trapezoidal. Frame 24 has first and second frame ends 24A and 24B which are connected by first and second frame sides 24C and 24D. Frame 24 optionally includes one or more longitudinal supports 24E that extend between frame ends 24A and 24B at one or more locations between frame sides 24C and 24D.

Frame ends 24A and 24B include inlet and outlet apertures 25A and 25B respectively that pass through frame ends 24A and 24B, respectively, into an interior region 26 of frame 24. Apertures 25A and 25B may include drafted (tapering) walls to reduce pressure drop in a flow passing through apertures 25A and 25B. Drafted walls in apertures 25A and 25B can also facilitate molding separator 20 (e.g. by allowing sliding parts of a mold to be retracted after a separator 20 is molded).

Interior region 26 of frame 24 includes flow field elements 26A that help to guide a flow of fluid to pass through interior region 26 between apertures 25A and apertures 25B. When a membrane sheet (not shown in FIGS. 2 and 2A) is disposed on the upper face 24-1 and lower face 24-2 of separator 20 a plurality of parallel channels 27 are defined between the membrane sheets and adjacent pairs of flow field elements 26A, and between the membrane sheets and frame sides 24C and 24D and their adjacent flow field element 26A.

Flow field elements 26A may, for example, have the form of ribs that extend between frame ends 24A and 24B. The height or thickness of flow field elements 26A (in a direction that is perpendicular to the plane of separator 20) may be greater than their width (in a direction perpendicular to their length and parallel to the plane of separator 20). The widths of flow field elements 26A may be made small to increase or maximize the area for vapor exchange between the first and second flows and/or to increase or maximize cross-sectional areas of channels 27 for a given footprint of separator 20. The widths of flow field elements 26A may optionally be varied along their length, and/or the widths of flow field elements and/or spacing between them may vary from one to another.

The thickness of flow field elements 26A is preferably substantially equal to the thickness of frame sides 24C and 24D, so that the upper and lower surfaces of frame sides 24C and 24D and of flow field elements 26A on faces 24-1 and 24-2 of separator 20 are substantially coplanar.

The spacing between adjacent flow field elements 26A may be selected to provide a desired degree of support to membrane sheets 22-1 and 22-2 while increasing or maximizing the active area of membrane sheets 22-1 and 22-2 available for providing exchange of water vapor between the first and second flows. The spacing may be selected, for example based on mechanical properties of membrane sheets 22-1 and 22-2 at temperatures within an anticipated operating temperature range, a maximum anticipated pressure differential across membrane sheets 22-1 and 22-2, expected variation in pressure differential during operation, a design lifetime, and a level of pre-tension, if any, applied to membrane sheets 22-1 and 22-2. In some embodiments adjacent flow field elements 26A are spaced apart from one another by distances in the range of 1 to 5 mm (e.g. 2 to 3 mm in some embodiments).

Longitudinal supports 24E have substantially the same thickness as frame sides 24C, 24D and flow field elements 26A. Longitudinal supports 24E are generally wider than flow field elements 26A as shown in FIGS. 2 and 2A.

Lateral supports 26B may be provided to brace and laterally stiffen flow field elements 26A. The thickness of lateral supports 26B (in a direction perpendicular to the plane of separator 20) is less than the thickness of frame sides 24C and 24D and flow field elements 26A, so that lateral supports 26B do not block or unduly obstruct channels 27. Preferably, lateral supports 26B are thin. Leading and trailing edges of lateral supports 26B are optionally shaped (e.g. tapered) to facilitate smooth flow through channels 27. Preferably lateral supports 26B are located so that they are not in contact with the adjacent membrane sheets 22-1 and 22-2, and fluid can pass above or below them in channels 27, for example, lateral supports 26B can be located at a center plane of separator 20.

As shown in FIGS. 2, 2A and 2B, frame end 24A includes a ridge 28A on upper face 24-1 of separator 20, and a ridge 29A on lower face 24-2 of separator 20. Frame end 24B includes a ridge 29B on upper face 24-1 of separator 20, and a ridge 28B on lower face 24-2 of separator 20. Ridges 28A, 29A extend along the length of frame end 24A, and ridges 28B, 29B extend along the length of frame end 24B.

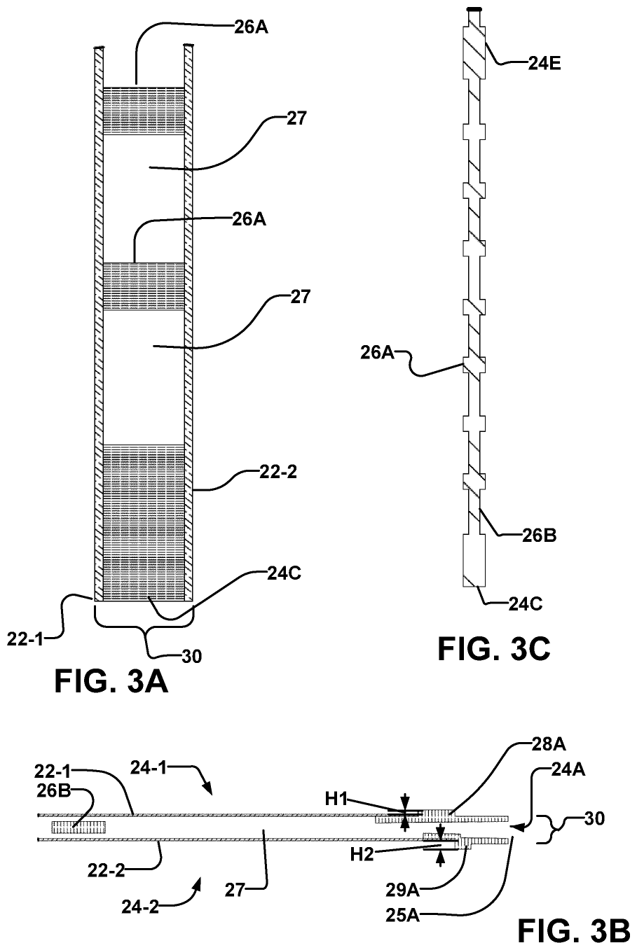

FIGS. 3A and 3B are cross-sectional views of portions of a unit cell 30. FIG. 3A is a partial cross-section on a cut plane perpendicular to the plane of the unit cell that extends through frame side 24C, in a direction perpendicular to the length of frame side 24C. FIG. 3B is a partial cross-section on a cut plane perpendicular to the plane of the unit cell that extends through frame end 24A in a direction perpendicular to the length of frame end 24A. FIG. 3C is a partial cross-sectional view of a portion of a separator 20 on a cut plane perpendicular to the plane of separator 20 that extends through frame side 24C, in a direction perpendicular to the length of frame side 24C, and through lateral supports 26B and flow field elements 26A, perpendicular to the length of flow field elements 26A.

FIG. 3A illustrates that membrane sheets 22-1 and 22-2 are supported by frame side 24C and flow field elements 26A. Membrane sheets 22-1 and 22-2 are also supported along their opposing edges by frame side 24D (not shown in FIG. 3A). Membrane sheets 22-1 and 22-2 may be attached to separator 20. The attachment between the membrane sheets and separator 20 may be provided, for example, by ultrasonic welding, laser welding, heat bonding, adhesive bonding, insert molding, or other suitable attachment means.

In some embodiments membrane sheets 22-1 and 22-2 are both attached to separator 20 around the periphery of interior region 26 of frame 24. In some embodiments the attachment is substantially continuous. For example, a line of attachment between membrane sheet 22-1 and upper surface 24-1 of separator 20 may extend around separator 20 along the upper surfaces of frame sides 24C and 24D and frame ends 24A and 24B; and a line of attachment between membrane sheet 22-2 and lower surface 24-2 of separator 20 may extend around separator 20 along the lower surfaces of frame sides 24C and 24D and frame ends 24A and 24B. The line of attachment may be provided, for example, by an adhesive, by welding, or by insert molding.

Membrane sheets 22-1 and 22-2 are sealed to corresponding frame sides 24C and 24D, along their upper and lower surfaces respectively. The sealing may be provided by the attachment means.

As shown in FIG. 3B, membrane sheets 22-1 and 22-2 partially overlap frame end 24A. They similarly overlap frame end 24B. Membrane sheets 22-1 and 22-2 are sealed to upper and lower surfaces of frame ends 24A and 24B, respectively, along the lengths of frame ends 24A and 24B.

FIG. 3A illustrates how fluid flow channels 27 are defined between flow field elements 26A of separator 20 and membrane sheets 22-1 and 22-2. FIG. 3C illustrates how lateral supports 26B extend across the width of channels 27. A fluid can enter channels 27 through apertures 25A that pass through frame end 24A (as shown in FIG. 3B) and exit channels 27 through apertures 25B.

As shown in FIGS. 2, 3B and 5, separator 20 includes ridges 28A and 28B (collectively ridges 28) and optional ridges 29A and 29B (collectively ridges 29). Ridges 28 and 29 individually or in combination serve several functions such as one or more of:
A. maintaining separation between membranes of adjacent unit cells 30;
B. sealing fluid flow channels or chambers between adjacent unit cells 30;
C. guiding positioning of membrane sheets 22-1 and 22-2 on each face of separator 20 during assembly of unit cells 30; and/or
D. facilitating alignment of unit cells 30 as they are stacked to form a humidifier core.

In the illustrated embodiment ridges 28 act as spacers which maintain separation between adjacent separators 20 and also act to seal both sides of channels 32 that are defined between adjacent unit cells 30.

In the illustrated embodiment, ridges 29 act as alignment features which facilitate alignment of adjacent separators 20 during assembly of a humidifier core 10, and also in combination with ridges 28 facilitate positioning of membrane sheets 22-1 and 22-2.

The above-noted functions provided by ridges 28 and 29 may be achieved with different arrangements of ridges 28 and 29. For example:
Ridges 28 may serve to maintain separation between adjacent unit cells 30 without optional ridges 29 being present.
Ridges 28A and 28B may be on the same face of separator 20, or on opposite faces (as illustrated in FIGS. 2 and 5) of separator 20;
Ridges 29 may be interrupted or replaced by rows of posts or other alignment features.

In the embodiment shown in FIGS. 2, 2A and 5, frame end 24A includes ridge 28A on face 24-1 and ridge 29A on face 24-2. In that embodiment, ridges 28A and 29A extend along the length of frame end 24A.

The separator 20 of FIGS. 2, 2A and 5 also includes ridge 28B which extends along the length of frame end 24B on face 24-2 and ridge 29B which extends along the length of frame end 24B on face 24-1.

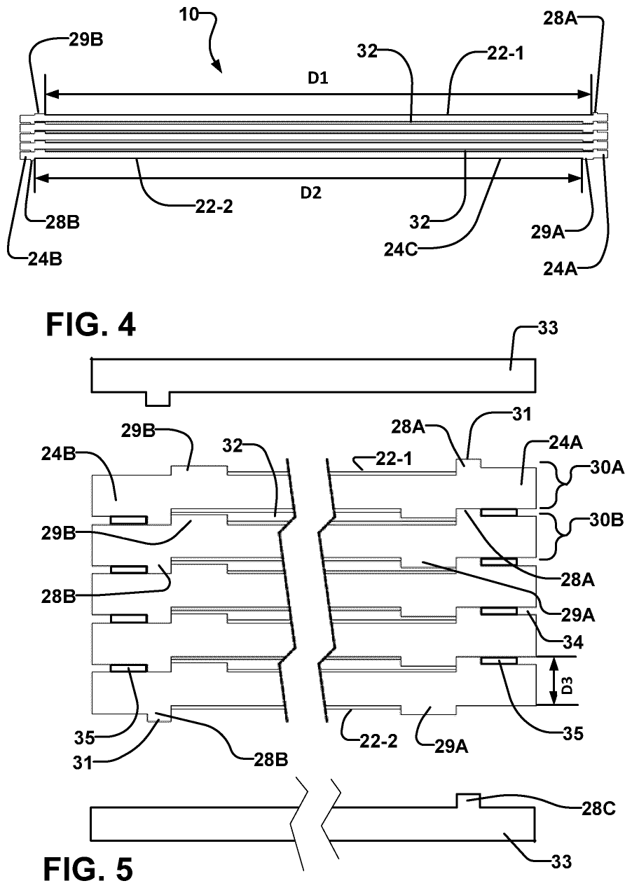

FIG. 4 is a partial side elevation view of humidifier core 10. As shown, for example in FIGS. 4 and 5, when unit cells 30 are stacked together, a surface 31 of ridge 28A of a first unit cell 30 may bear against separator 20 of a second unit cell 30 that is adjacent to the first unit cell 30, and a surface 31 of ridge 28B of the second unit cell 30 may bear against separator 20 of the first unit cell 30. This arrangement positively sets the spacing between the first and second unit cells 30 and defines the height of channel 32 between the first and second unit cells 30

As shown in FIG. 5, the unit cells 30 may be interposed between a pair of end plates 33. End plates 33 may be shaped to bear against top and bottom separators 20 in the stack. In the example shown in FIG. 5, end plates 33 have ridges 28C which bear against an adjacent separator 20.

As shown in FIG. 4 ridges 28A and 29B (on upper surface 24-1 of separator 20) are separated by a distance D1. Ridges 29A and 28B (on lower surface 24-2 of separator 20) are separated by a distance D2. Membrane sheets 22-1 may be cut or sized to fit between ridges 28A and 29B. Membrane sheets 22-2 may be cut or sized to fit between ridges 29A and 28B. These features can help with alignment of membrane sheets 22-1 and 22-2 to separator 20 during assembly of a unit cell 30. Where D1 and D2 are equal or nearly equal, membrane sheets 22-1 and 22-2 may advantageously have the same dimensions. In the example shown in FIG. 4, membrane sheets 22-1 and 22-2 are offset from one another in a direction along separator 20 by a distance equal to a width of ridges 29A and 29B.

In some embodiments, ridges 28A and 28B are equal in height (and have height H1 as shown in FIG. 3B) and are taller than ridges 29B and 29A. Ridges 29B and 29A may have height H2 (as shown in FIG. 3B), where H21≤11 and preferably where H2<H1. In some embodiments one or both of ridges 29 are wider than ridges 28.

In the embodiment illustrated in FIGS. 1-5, when unit cells 30 are aligned in a stack, one of ridges 29 on one separator 20 abuts a ridge 28 on the adjacent separator This contact or engagement helps to align unit cells 30 to form a humidifier core 10.

In the example humidifier core 10 illustrated in FIGS. 4 and 5, separators 20 are rotationally symmetric with respect to rotation of 180 degrees about a transverse axis (in the mid-plane of the separator) that passes through centers of frame sides 24C and 24D. This simplifies assembly of a humidifier since unit cells 30 can be oriented either way. All separators 20 and unit cells 30 in humidifier core 10 can have the same orientation. This significantly simplifies assembly as compared to designs which require that similar components must be rotated relative to one another in some specific way.

In FIGS. 4 and 5 it can be seen that wide cross-channels 32 are defined between adjacent unit cells 30 of humidifier core 10. Cross-channels 32 extend across humidifier core 10 (from frame sides 24C to frame sides 24D). A flow of fluid through a cross-channel 32 can exchange moisture with a flow of fluid through channels 27 in the unit cells 30 on either side of each cross-channel 32. Membrane sheets 22-1 and 22-2 are supported by separators 20 and can be flat or nearly flat. The design of unit cells 30 does not require any sharp bends in membrane sheets 22-1 or 22-2. Sharp bends can create failure points in a membrane.

Advantageously, the design of humidifier core 10 permits dimensions of channels 32 and 27 to be independently set. The height of channels 32 is set by the heights of ridges 28. The dimensions of channels 27 are set by the design of separators 20. The flow geometry can be selected or optimized for each flow domain. For example:
A. the relative length of channels 27 and 32 may be adjusted by changing the aspect ratio (ratio of length to width) of frame 24.
B. the height of channels 32 may be adjusted by altering the height of ridges 28.
C. The height of channels 27 may be adjusted by altering the thickness of frame 24.

The design of each flow domain may, for example, be selected or optimized for one or more of:
height (i.e. low or minimum height to increase or maximize active area of a membrane in a given stack height);
to achieve more even or uniform flow distribution; and
to reduce or minimize pressure drop.

In many fuel cell humidifier applications there is a significant difference in pressure between the drier stream of gas being humidified (receiving water) and the more humid stream of gas that provides the water. For example, it is common for the drier stream of gas to be at higher pressure than the more humid stream of gas. The pressure differential typically ranges from 50 kPa to 100 kPa. In humidifier core 10, the higher pressure flow of gas may be directed through cross-channels 32 while the lower pressure flow of gas may be directed through channels 27. With this arrangement the pressure differential across membrane sheets 22-1 and 22-2 forces membrane sheets 22-1 and 22-2 against flow field elements 26A and longitudinal supports 24E which provide mechanical support for membrane sheets 22-1 and 22-2 on either side of separator 20.

The widths of channels 27 and the selection of material for membrane sheets 22 may be selected to allow operation of a humidifier at a desired pressure differential and at a desired temperature while keeping deflection of membrane sheets 22 below a threshold deflection.

As seen in FIG. 5, frame 24 of a first unit cell 30A is spaced apart from frame 24 of an adjacent second unit cell 30B by ridge 28B of first unit cell 30A and ridge 28A of second unit cell 30B, with surface 31 of ridge 28B of first unit cell 30A contacting separator 20 of second unit cell 30B, and the surface 31 of ridge 28A of second unit cell 30B contacting separator 20 of first unit cell 30A. This direct contact between the separators 20 of the first and second unit cells provides a ‘hard stop’ when a stack of unit cells 30 is assembled together. The height of the stack of unit cells 30 is determined by the dimension D3 of separators 20. The thicknesses of membrane sheets 22-1 and 22-2, which can change, for example due to swelling of the membranes, does not affect the height of the stack of unit cells 30.

Ridges 29, if present, may be of lower height than ridges 28 (H2<H1 as shown in FIG. 3B). In some embodiments a membrane (such as membrane sheet 22-1 or membrane sheet 22-2) of an adjacent unit cell 30 extends into the space between ridge 29 and an adjacent separator 20. It is not necessary for ridges 29 to contact the membrane.

The ‘hard stop’ provided by ridges 28 when unit cells 30 are stacked helps to reduce or avoid failure of seals between adjacent unit cells 30. This mitigates failure modes that can afflict humidifiers of types in which the height of a humidifier core is determined in part by membranes. In a humidifier core for which the stack height is determined by membrane thicknesses, variation in stack height may be caused by the membranes swelling and shrinking in thickness during operation of the humidifier, and can cause premature failures in seals of the humidifier core. Over-compressing the stack to ensure effective sealing between layers may introduce other failure modes, for example puncturing the membrane.

In the embodiment illustrated in FIGS. 1-5, ridges 28 and 29 are all inset relative to frame ends 24A and 24B of separators 20. Having ridges 28 and 29 inset relative to the ends of separator 20 is beneficial but not essential. When unit cells 30 are stacked, transverse grooves 34 (see FIG. 5) are formed between separators 20 of adjacent unit cells 30. Grooves 34 may receive a suitable material 35, such as an adhesive or sealant, which holds the stack of unit cells 30 together. Preferably, material 35 is selected to be robust to operating conditions and viscous enough that it does not flow to block apertures 25A or 25B during assembly of the humidifier cores. In some embodiments material 35 is a curable sealant and may be UV curable. Advantageously material 35 does not affect the height of the stack of unit cells 30.

In some embodiments additional structure is provided to hold unit cells 30 together in a humidifier core 10. The additional structure may, for example, be provided by wires, bands or straps that extend around humidifier core 10, a frame or cage that receives and holds together unit cells 30 and end plates 33 of a humidifier core 10 or the like.

In an example embodiment, a humidifier core 10 comprises a stack of unit cells 30 that is received within a stainless steel frame. The frame may, for example comprise a pair of end plates connected by four corner posts. Different parts of the frame may be welded, bonded, or attached by deformable elements such as bendable or twistable tabs. The frame may hold unit cells 30 in alignment and maintain the compression on the stack of unit cells 30. In some embodiments a humidifier core 10 may be removably installed in a housing so that the stack can be installed or removed from the housing in a fashion similar to the installation or removal of an air filter or cartridge.

A humidifier core 10 may be housed in a housing 60 (see e.g. FIG. 11). In the illustrated embodiment, housing 60 comprises a base 61A, a hollow body 61B dimensioned to receive humidifier core 10, and a cap 61C. Bolts 62 or other fasteners attach cap 61C and base 61A to body 61B to enclose humidifier core 10. Edge seals 61D within body 61B seal against corners of humidifier core 10. Fluid ports 63A and 63B respectively carry a first flow of gas to pass into and out of housing 60 via channels 27 (not shown in FIG. 11) in humidifier core 10. Ports 64A and 64B respectively carry a second flow of gas to pass into and out of housing 60 via channels 32 (not shown in FIG. 11) in humidifier core 10.

The opposing faces of humidifier core 10 (formed by stacked frame sides 24C and 24D respectively) which contain the open ends of channels 32 may be at least generally planar so as to facilitate sealing between humidifier core 10 and conduits that are arranged to carry fluids to and from humidifier core 10. To facilitate such sealing, ends of all ridges 28 and 29 (if present) may be flat and coplanar with the outer edges of frame sides 24C and 24D.

The heights of grooves 34 may be made to be different from the height of channels 32 by making the parts of frame ends 24A and 24B that are respectively outward of ridges 28 different in thickness from frame sides 24C, 24D and from the parts of frame ends 24A and 24B that are respectively inward from ridges 28 and 29. In the embodiment illustrated in FIGS. 1-5, the parts of frame end 24A that are outward of ridges 28A and 29A and the parts of frame end 24B that are outward of ridges 28B and 29B are thicker than the parts of frame ends 24A and 24B that are inward from ridges 28 and 29 such that grooves 34 have heights that are smaller than the height of channels 32. The extra thickness of these parts of frame ends 24A and 24B can facilitate drafting apertures 25A and 25B as described elsewhere herein.

Advantageously, in some embodiments ridges 28 and 29 constrain membrane sheets 22-1 and 22-2 and serve as barriers between edges of membrane sheets 22-1 and 22-1 and the faces of humidifier core 10 which include apertures 25A and 25B. This construction may mitigate potential failure modes associated with swelling of membrane sheets 22-1 and 22-2 as a result of exposure to high humidity of the gas entering apertures 25A.

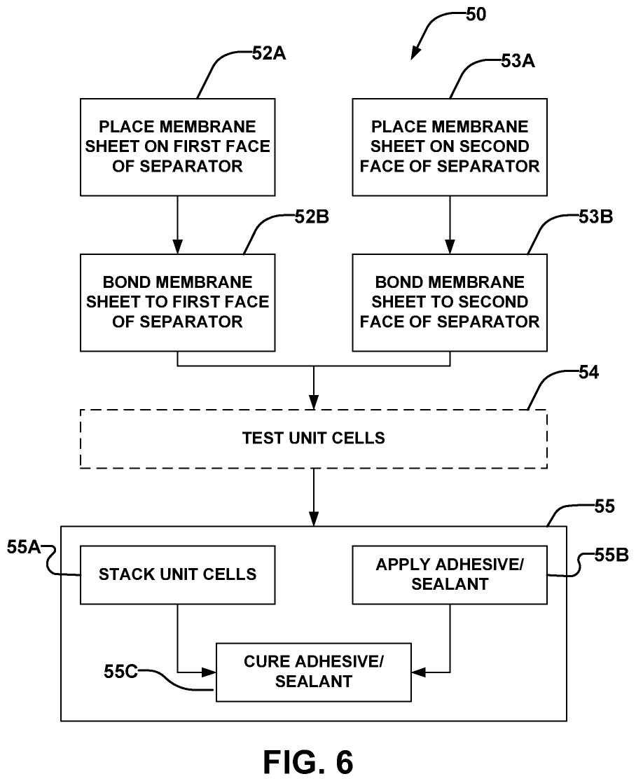

FIG. 6 is a flow chart that illustrates an example method 50 for assembling a humidifier core. In block 52A, membrane sheet 22-1 is placed at the correct location on face 24-1 of a separator 20. Block 52A may comprise fitting a pre-cut membrane sheet 22-1 between ridges 28A and 29B on the separator 20.

In block 52B, membrane sheet 22-1 is bonded to separator 20. Block 52B may, for example include bonding membrane sheet 22-1 to separator 20 to form a continuous seal around a periphery of membrane sheet 22-1.

In block 53A, membrane sheet 22-2 is placed at the correct location on face 24-2 of the separator 20. Block 53A may comprise fitting a pre-cut membrane sheet 22-2 between ridges 29A and 28B on the separator 20.

In block 53B, membrane sheet 22-2 is bonded to separator 20. Block 53B may, for example include bonding membrane sheet 22-2 to separator 20 to form a continuous seal around a periphery of membrane sheet 22-2.

Blocks 52B and 53B may, for example comprise ultrasonic welding, laser welding, heat bonding, adhesive bonding or the like to attach the respective membrane to the separator 20.

Blocks 52A and 52B may be performed in any order or simultaneously relative to blocks 53A and 53B. At the completion of both of blocks 52B and 53B a unit cell 30 has been created. In optional block 54 unit cells 30 are tested (e.g. to ensure that the chambers formed by the membrane sheets and separator in each of the unit cells 30 are gas tight).

In block 55 multiple unit cells 30 are assembled to form a humidifier core 10. In block 55A a desired number of unit cells 30 are stacked together. Block 55A may include aligning the unit cells 30 by engaging ridges of adjacent unit cells 30 in an abutting relationship (e.g. ridge 28A of one unit cell 30 may be brought to abut ridge 29A of an adjacent unit cell 30). Advantageously, all of the stacked unit cells may be stacked in the same orientation. Block 55A may comprise providing end plates 33 at opposing ends of the stack.

In block 55B material 35, which may be a curable adhesive sealant, is applied to the unit cells 30. Block 55B may be performed before, during or after block 55A. In an example embodiment, unit cells 30 are sequentially added to a stack of unit cells. Before each unit cell is added to the stack, material 35 (for example a bead of adhesive sealant) is applied to a surface that will be a wall of a groove 34. When each unit cell is added to the stack the added unit cell may be spaced the correct distance apart from the previous unit cell by engagement of surfaces 31 of ridges 28. Material 35 holds the stacked unit cells 30 together.

In block 55C the completed stack of unit cells may be clamped together until material 35 cures. Method 50 optionally includes adding a frame, banding, wires or the like to compress the stack of unit cells together and/or hold the unit cells together in the stack.

It can be appreciated from the foregoing that the present technology provides a range of designs for humidifiers that can operate to transfer moisture between flows that are at different pressures. The humidifiers may be assembled by stacking together unit cells which each include a separator, which can define a flow path for a lower-pressure flow, and has water vapor transport (WVT) membranes bonded to both sides of the separator. Both cross-flow, counter-flow or co-flow arrangements are possible.

In preferred embodiments the unit cells are identical and symmetrical. In such embodiments, assembly is simplified because a unit cell can be added to a stack of unit cells with either face against the stack. A higher pressure flow can flow through passages between adjacent unit cells.

The flow geometry can be selected or optimized for each flow.

The apparatus described herein may be varied in various ways. For example, different embodiments may include one or more of the features described in the following paragraphs.

In some embodiments, flow field elements 26A define a flow field in which channels 27 are not straight. For example, channels 27 may be straight, wavy, angled, or have other configurations within interior region 26 of separators 20.

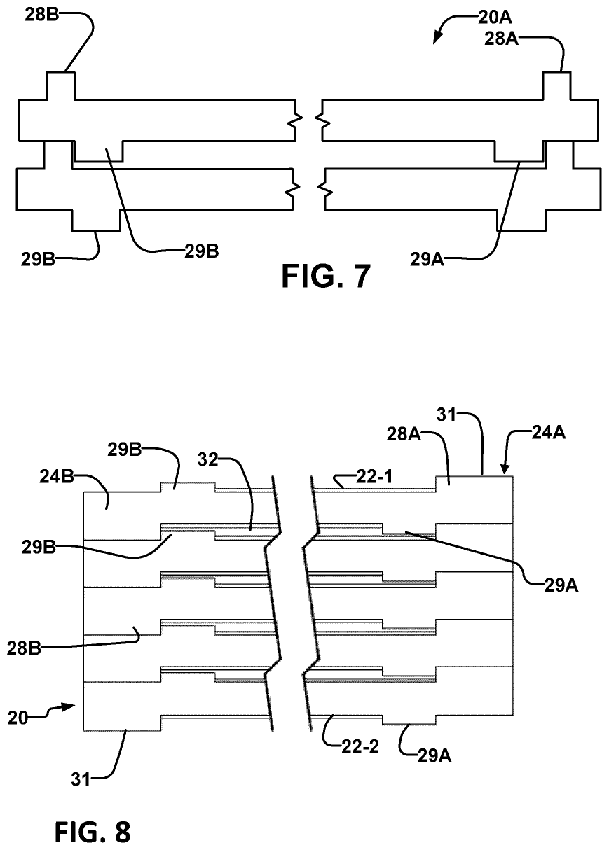

In some embodiments of the humidifiers described herein, the separators are symmetrical across a plane that intersects the midpoints of frame sides 24C, 24D and is perpendicular to the plane of separator 20. In some such embodiments, for example, the ridges that maintain a hard stop separation between adjacent separators 20 may be provided on the same face of the separator (rather than opposite faces as in the embodiment illustrated in FIGS. 1-5). For example, taller ridges 28A and 28B that provide a hard stop when separators 20 are stacked may both be on the same face of separator Ridges 29A and 29B may be on the opposing face of separator 20 and offset relative to ridges 28A and 28B, respectively. FIG. 7 is a side elevation view of two stacked separators 20A that have this alternative construction. Each separator 20A can have a membrane sheet (not shown in FIG. 7) attached to its upper face and to its lower face to form a unit cell. Unit cells can be stacked to form a humidifier core. In this embodiment, the dimensions of the membrane sheet attached to the upper surface of the separator may be different from the dimensions of the membrane sheet attached to the lower surface of separator 20A.

In the embodiment illustrated in FIGS. 1-5, ridges 28A and 29A are inset relative to end 24A of separator 20, and ridges 29A and 29B are inset relative to end 24B of separator 20. As noted above, having ridges 28 and 29 inset relative to the ends of separator 20 can be beneficial but is not essential. FIG. 8 shows a partial side elevation view of a humidifier core. In this embodiment, ridges 28A and 28B, which provide the hard stop separation between adjacent unit cells, are located flush with the frame ends 24A and 24B of the respective separators 20. Ridges 29A and 29B, which can facilitate alignment and positioning of adjacent unit cells, are inset relative to frame ends 24A and 24B respectively, and ridges 28A and 28B respectively.

FIG. 9 is a perspective view of an example of a rectangular separator that has a width that is different from its length. Otherwise the separator shown in FIG. 9 is similar to the separator illustrated in FIG. 2, and the same reference numerals are used to indicate similar or the same components, parts or features.

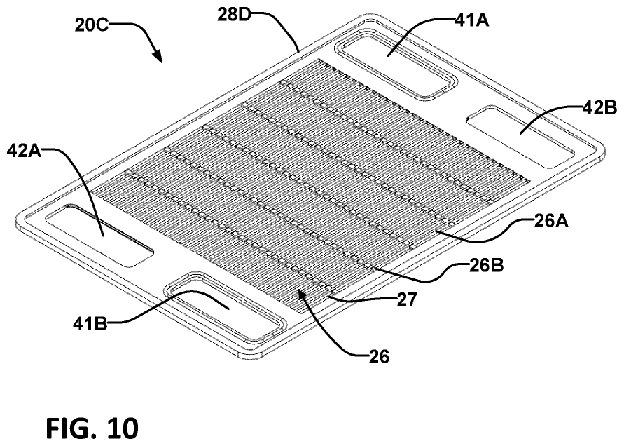

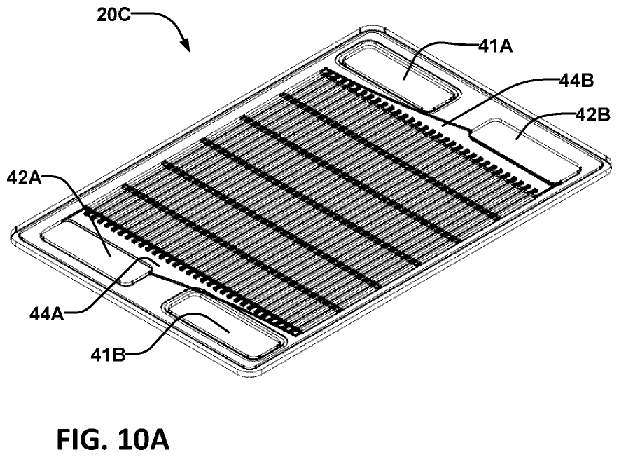

In some embodiments separators define ports that distribute flows among and in between unit cells of a humidifier core. Some such separators, when stacked may provide counter-flow humidifiers. For example, FIGS. 10 and 10A show a separator 20C which has a flow field arranged similar to the rectangular separator shown in FIG. 9 to provide counter-flow humidity exchange. As in other embodiments described herein, membranes (not shown in FIG. 10 or 10A) may be affixed to separator 20C to cover opposing faces of the flow field, forming a unit cell.

Separator 20C includes a peripheral ridge 28D that provides a hard stop when stacked adjacent to an adjacent separator 20C. Separator 20C may optionally include alignment features on its face opposed to peripheral ridge 28D. The alignment features may, for example, align two stacked separators 28D by engaging against inside and/or outside surfaces of peripheral ridge 28D.

When several separators 20D (each with a membrane sheet on both faces) are stacked, port openings 41A, 41B, 42A and 42B of the stacked separators are aligned to provide corresponding manifolds that extend through the stack of separators.

Port openings 41A and 41B align to form manifolds to carry a first flow that passes through spaces between adjacent unit cells, each unit cell comprising a separator 20C interposed between a pair of membrane sheets. Port openings 42A and 42B align to form manifolds to carry a second flow that passes through a flow field in interior region 26 within the separator 20C. For example, the second flow may be delivered into aligned port openings 42A, flow into interior region 26 by way of a header region 44A defined in separator 20C, pass through interior region 26 to a collection region 44B that collects the flow and delivers the flow to port 42B. Suitable seals or gaskets can be used to maintain separation of the first and second flows.

### INTERPRETATION OF TERMS

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “upper”, “lower”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a component (e.g. a membrane, sealant, adhesive, assembly, device, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

Various features are described herein as being present in “some embodiments”. Such features are not mandatory and may not be present in all embodiments. Embodiments of the invention may include zero, any one or any combination of two or more of such features. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B even if features A and B are described with respect to different Figures and/or are mentioned in different paragraphs or different sentences (unless the description states otherwise or features A and B are fundamentally incompatible).

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

1. A humidifier comprising:
a stack of unit cells, each of the unit cells comprising a separator having a perimeter frame and first and second major faces, a first membrane sheet bonded to the perimeter frame on the first major face of the separator and a second membrane sheet bonded to the perimeter frame on the second major face of the separator;
wherein:
the perimeter frame and the first and second membrane sheets define a cavity in an interior of the perimeter frame;
opposed first and second frame ends of the perimeter frame define passages to allow a first flow to flow through the cavity in a first direction;
the separator includes first and second ridges that extend respectively across the first and second frame ends; and
in the stack of unit cells the first and second ridges space the unit cells apart from one another by contact with the separators of adjacent unit cells to provide transverse passages extending through the stack of unit cells in a second direction transverse to the first direction.

2. The humidifier according to claim 1 wherein the first and second ridges are respectively inset inwardly from outer edges of the first and second frame ends.

3. The humidifier according to claim 2 wherein portions of the first frame ends between the first ridges and the outer edges of the first frame end are spaced apart from one another in the stack of unit cells by first gaps and the first gaps contain adhesive that bonds the adjacent unit cells together.

4. The humidifier according to claim 3 wherein portions of second frame ends between the second ridges and the outer edges of the second frame end are spaced apart from one another in the stack of unit cells by second gaps and the second gaps contain adhesive that bonds the adjacent unit cells together.

5. The humidifier according to claim 1 wherein the first and second ridges are respectively on first and second opposing faces of the separators.

6. The humidifier according to claim 5 wherein the separators are each symmetrical with respect to rotations of 180 degrees about a transverse axis centered in the separators.

7. The humidifier according to claim 5 comprising a third ridge on the first frame end on the second face of the separator, wherein an outer edge of the third ridge is aligned with an inner edge of the first ridge.

8. The humidifier according to claim 7 wherein the third ridge has a height measured from a side of the perimeter frame that is less than a height of the second ridge measured from the side of the perimeter frame.

9. The humidifier according to claim 1 wherein the first and second membrane sheets each comprises a porous substrate and a water vapor permeable coating on one face of the porous substrate.

10. The humidifier according to claim 9 wherein the first and second membrane sheets are each oriented so that the water vapor permeable coating faces away from the separator to which the first and second membrane sheets are attached.

11. The humidifier according to claim 8 wherein the porous substrates of the first and second membrane sheets comprise PPS plastic and the substrate comprises PPS plastic.

12. The humidifier according to claim 1 wherein the first and second membrane sheets are bonded to the separator around a periphery of the cavity.

13. The humidifier according to claim 1 comprising a plurality of flow field elements extending across the cavity between the first and second frame ends, the flow field elements spaced apart to define channels extending across the cavity.

14. The humidifier according to claim 13 wherein opposing surfaces of the flow field elements are coplanar with first and second major faces of the separator.

15. The humidifier according to claim 14 wherein adjacent ones of the flow field elements are spaced apart from one another by distances in the range of 1 to 5 mm.

16. The humidifier according to claim 14 wherein each of the separators comprises a plurality of lateral supports that extend between adjacent ones of the flow field elements and are dimensioned to not occlude the channels.

17. The humidifier according to claim 13 wherein the first and second frame ends are each formed to provide a plurality of apertures that extend through the first and second frame ends and each open into a corresponding one of the channels.

18. The humidifier according to claim 17 wherein the apertures are formed to have drafted walls.

19. The humidifier according to claim 1 wherein the cavity has an aspect ratio of width:length in the range of 1:1.2 to 1.2:1.

20. The humidifier according to claim 1 wherein the transverse passages have heights that are greater than a thickness of a portion of the perimeter frame at which the first membrane sheet is bonded to the perimeter frame.

21. The humidifier according to claim 1 comprising a frame surrounding the stack of unit cells, the frame tensioned to apply compression to the stack of unit cells.

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)
